(19) United States
(12) Patent Application Publication
(10) Pub. No.: US 2022/0148005 A1
(43) Pub. Date: May 12, 2022

(54) Method for processing a payment transaction, and corresponding device, system and programs

(71) Applicant: BANKS AND ACQUIRERS INTERNATIONAL HOLDING, PARIS (FR)

(72) Inventors: Michel Leger, PARIS (FR); Pierre Quentin, ENGHIEN LES BAINS (FR); Arnaud Dubreuil, PARIS (FR); Quitterie D'Avout, PARIS (FR); Jérôme Marcon, PARIS (FR)

(21) Appl. No.: 17/431,920

(22) PCT Filed: Feb. 18, 2020
(86) PCT No.: PCT/EP2020/054184

§ 371 Date: Aug. 18, 2021

(30) Foreign Application Priority Data
Feb. 19, 2019 (FR) 1901669

(51) Int. Cl. G06Q 20/40

(52) U.S. Cl. CPC G06Q 20/40145

(57) ABSTRACT

A method for processing a product or service purchase order, which is implemented within a voice-based electronic processing device including a capturing component for capturing voice orders and a sound broadcast component. The method includes: obtaining, using the capturing component, at least one item of data representing a voice-based purchase order, the purchase order emanating from the voice of a user and relating to the purchase of at least one product or service; authenticating at least one voiceprint representing the user based on the item of data representative of the purchase order; and if the at least one voiceprint representative of the user corresponds to a user authorized to make purchases using the voice-controlled electronic device, transmitting, to an electronic processing device to which the voice-controlled electronic device is connected, a request to obtain purchase authorization, the request including at least one item of data representing the payment transaction.

### CROSS-REFERENCE TO RELATED APPLICATIONS

This application is a Section 371 National Stage Application of International Application No. PCT/EP2020/054184, filed Feb. 18, 2020, the content of which is incorporated herein by reference in its entirety, and published as WO 2020/169570 on Aug. 27, 2020, not in English.

### 1. TECHNICAL FIELD

The invention relates to the implementation of payment transactions. The invention relates more particularly to the implementation of a payment transaction which comprises the use of a voice interface. The invention relates more particularly to providing a simple and secure method for processing payment transactions, minimising user data exposure.

### 2. PRIOR ART

A growing proportion of households are equipped with voice control devices. Such devices are also known as smart speakers. These voice control devices embed multiple functionalities, including, for some, the possibility of placing orders for goods and services. For example, Amazon™'s voice control device offers the possibility of ordering goods and services on the Amazon™ retail platform. However, this possibility is only offered via the installation of an application on the user's communication terminal. This application must be configured with payment options and must be used to help validate orders which are placed vocally. Indeed, voice-controlled purchasing of products can be dangerous in the wrong hands, especially when children or strangers are living or visiting the home of the user who owns the voice control device. To avoid this, the only possibility currently offered consists of conditioning the validation of orders placed vocally by adding a confirmation code on a specific application installed in the communication terminal which is paired with the voice control device. It is noted that this conditioning, by entering a confirmation code on the communication terminal, is optional and not provided by default. By default, any order placed using the voice control device is automatically validated by the user, without the latter being able to intervene in the order process (particularly if the user placing the order is not the user who owns the voice control device).

However, the method as disclosed above comprises shortcomings. Firstly, this method requires the user to interact with the communication terminal in their possession, for at least two different actions: configuring the communication terminal which is paired with the voice control device, and validating the payment transaction. For this purpose, the user must install a specific application on their communication terminal and configure it and they must validate the transaction on the terminal. Having to validate the transaction on the communication terminal can be a quite coherent measure from a security point of view. On the other hand, having to install a specific application on a communication terminal can be redhibitory for a certain number of users. Moreover, within the scope of the method described above, there is no authentication of the user who places the order. Instead of authentication, the use of the paired communication terminal is accepted to optionally validate the transaction. Furthermore, in terms of the payment transaction, i.e. the validation of the order, the same “login/password” pairs are used both by the voice control device and by the communication terminal. This is due to the fact that once it is configured, the voice control device is autonomous and connects directly to the servers of the manufacturer of this voice control device (or to the servers of the voice service provider) to, on one hand, be able to interact with the user and, on the other, be able to perform searches and actions according to the user's voice commands. Thus, placing an order, resulting in a purchase of goods or services via a voice control device is not sufficiently secure.

### 3. SUMMARY OF THE INVENTION

The invention does not pose at least some of the problems of the prior art. More particularly, the invention relates to a process for processing a payment transaction for a good or a service ordered using a voice control device by a user vocally stating their intention to make a purchase of goods or services.

More particularly, the invention relates to a method for processing a purchase order of goods or services, said method being implemented within an electronic voice processing device comprising at least one component for capturing voice orders, called capturing component, and a sound emission component, called emission component. Such a method consists in:
Obtaining, using the capturing component, at least one data item representative of a voice-based purchase order, said purchase order emanating from the voice of a user and relating to the purchase of at least one good or one service;
Authenticating at least one voiceprint representative of said user based on said at least one data item representative of the purchase order;
determining whether at least one voiceprint representative of said user corresponds to a user authorised to make purchases using said electronic voice control device; and
transmitting, to an electronic processing device to which said electronic voice control device is connected, a request to obtain a purchase authorisation, said request comprising at least one data item representative of the payment transaction, as a function of the determination.

Thus, the invention makes it possible to ensure that the user attempting to place an order via the voice recognition device is authorised to do so. Thus, the authorisation to place an order is handled directly on the voice control device, without requiring a communication terminal. Searching for the communication terminal paired with the voice control device is thus first of all avoided.

According to a particular embodiment, the electronic processing device is a communication terminal with which said voice control device has been previously paired.

According to a particular feature, transmitting the request to obtain a purchase authorisation to the communication terminal with which said electronic device is paired comprises:

Building the request to obtain the purchase authorisation;

Activating the emission component of the electronic device;

Generating a sound according to the request to obtain the purchase authorisation;

Emitting said sound using the emission component.

Thus, the invention makes it possible to ensure that the communication terminal from which the payment authorisation is requested is near said electronic voice processing device.

According to a particular embodiment, said sound emitted by said electronic voice processing device is situated in the ultrasound range.

Thus, the sound transmitted to the communication terminal with which the voice control device is paired is inaudible.

According to a particular feature, the method further comprises, after transmitting the request to obtain a purchase authorisation, receiving a payment transaction acceptance response.

According to a particular embodiment, the method for processing a payment transaction further comprises, after receiving a payment transaction acceptance response, a step of transmitting a data structure representative of the payment transaction to a transaction server.

According to a particular embodiment, the data structure representative of the payment transaction comprises at least one data item representative of a current voiceprint.

According to a particular feature, said at least one data item representative of a current voiceprint is used to replace at least one payment data item of a payment card of said user.

According to a particular embodiment, said at least one data item representative of a current voiceprint is used to build a payment token using at least one payment data item of a payment card of said user.

According to a further aspect, the invention also relates to an electronic voice processing device, device being capable of processing a purchase order of goods or services, of an electronic voice processing device comprising at least one component for capturing voice orders, called capturing component, and a sound emission component, called emission component, device comprising means:
For obtaining, using the capturing component, at least one data item representative of a voice-based purchase order, said purchase order emanating from the voice of a user and relating to the purchase of at least one good or one service;
Means for authenticating at least one voiceprint representative of said user based on said at least one data item representative of the purchase order; and
Means for transmitting, to an electronic processing device to which said electronic device is connected, a request to obtain a purchase authorisation, said request comprising at least one data item representative of the payment transaction, these transmission means being implemented as a function of a determination of whether said at least one voiceprint representative of said user corresponds to a user authorised to make purchases using said electronic voice control device.

According to a preferred implementation, the different steps of the methods according to the invention are implemented by one or more software or computer programs, comprising software instructions intended to be executed by a data processor of an execution device according to the invention and being designed to control the execution of the different steps of the methods, implemented at the level of the communication device, the electronic execution device and/or the remote server, within the scope of a distribution of the processing operations to be performed and determined by a scripted source code.

Consequently, the invention also relates to programs, capable of being executed by a computer or by a data processor, these programs including instructions for ordering the execution of the steps of the methods as mentioned above.

A program can use any programming language, and be in the form of source code, object code, or of intermediate code between source code and object code, such as in a partially compiled version, or in any other desirable form.

The invention also relates to a data medium readable by a data processor, and including instructions of a program as mentioned above.

The data medium can be any entity or device capable of storing the program. For example, the medium can include a storage means, such as a ROM, for example a CD-ROM of a microelectronic circuit ROM, or else a magnetic recording means, for example a mobile medium (memory card) or a hard drive or an SSD.

Moreover, the data medium can be a transmissible medium such as an electrical or optical signal, which can be routed via an electrical or optical cable, via radio or via other means. The program according to the invention can in particular be uploaded on an Internet type network.

Alternatively, the data medium can be an integrated circuit wherein the program is incorporated, the circuit being adapted to execute or to be used in the execution of the method in question.

According to an embodiment, the invention is implemented by means of software and/or hardware components. Accordingly, the term “module” can correspond in this document equally well to a software component, to a hardware component or to a set of hardware and software components.

A software component corresponds to one or more computer programs, one or more subprograms of a program, or more generally to any element of a program or software capable of implementing a function or a set of functions, as described below for the module in question. Such a software component is executed by a data processor of a physical entity (terminal, server, gateway, set-top box, router, etc.) and is capable of accessing the hardware resources of this physical entity (memories, recording media, communication bus, electronic input/output cards, user interfaces, etc.).

Similarly, a hardware component corresponds to any element of a set of hardware capable of implementing a function or a set of functions, as described below for the module in question. It can consist of a programmable hardware component or with an integrated processor for software execution, for example an integrated circuit, a chip card, a memory card, an electronic card for executing firmware, etc.

Each component of the system described above obviously implements its own software modules.

The different embodiments mentioned above can be combined with one another for the implementation of the invention.

### 4. DESCRIPTION OF THE FIGURES

Further features and advantages of the invention will emerge more clearly on reading the following description of a preferential embodiment, given by way of illustrative and non-restrictive example, and the appended drawings, wherein:

FIG. 1 describes a system wherein the invention is implemented;

FIG. 2 illustrates the processing of a purchase made according to a prior-art technique;

FIG. 3 illustrates the processing of a purchase made using the technique according to the invention;

FIG. 4 illustrates a voice control device according to the invention.

### 5. DESCRIPTION OF EMBODIMENTS

### 5.1. General Principle

As stated above, the general principle of the invention consists of implementing an authentication of the user who is placing a voice-based order, by means of a voice control device. According to the embodiments, the user authentication is performed either locally, on the voice control device itself, or remotely. Moreover, the invention also adds a validation operation, implemented automatically by the communication terminal with which the voice control device is paired. According to the embodiments, the user authentication and the validation operation by the communication terminal are implemented jointly or concomitantly, as described hereinafter.

Thus, firstly, the general principle of the invention is based on the authentication of the user placing the order. More particularly, when placing the order, the user's voice is authenticated, by comparisons of a current voiceprint with a reference voiceprint. This comparison is preferably implemented when the user says the keywords required to activate the voice control device.

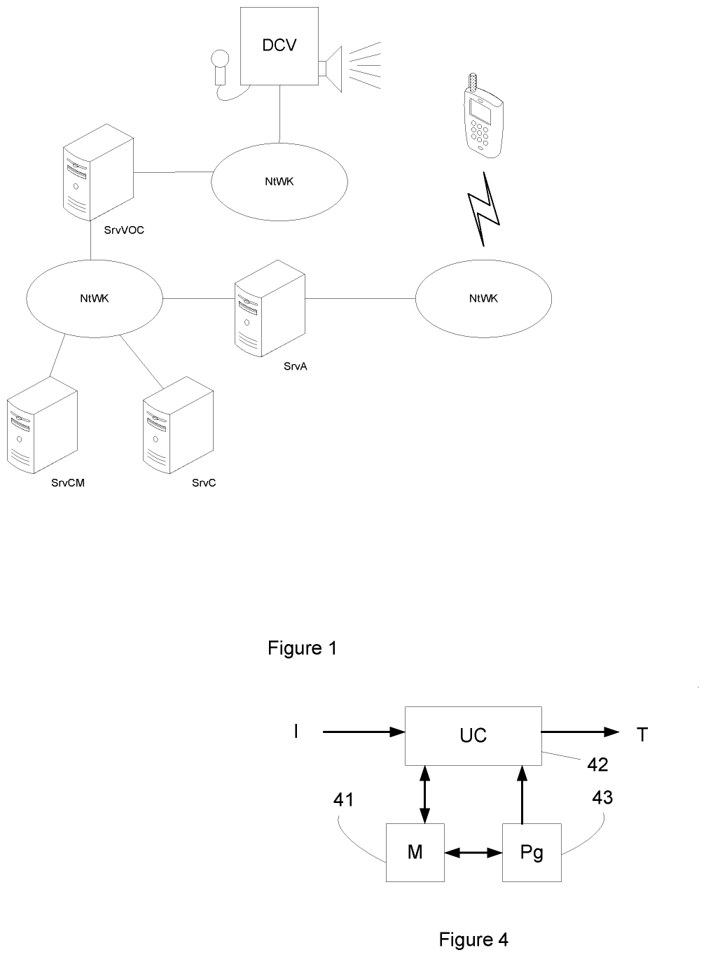

FIG. 1 describes a system wherein the technique described is implemented. Such a system comprises a voice control device DCV (which comprises a processing unit comprising a processor, memory, modules for receiving and transmitting data, such as network communication modules (wired and/or wireless Ethernet, Wi-Fi, Bluetooth type), at least one component for capturing voice commands (microphone), called capturing component, and a sound emission component (speaker), called an emission component. The voice control device is connected, via a communication network NtWK (using the network communication module(s)), to a server providing voice services SrvVoc. Such a server can concretely be presented in the form of a physical server and/or a set of servers distributed in a “cloud” type decentralised processing infrastructure. The server SrvVoc is in turn connected, using the same communication network NtWK (or another communication network) to one or more servers SrvC offering complementary functions (for example merchant server SrvCM, authentication server SrvCA, transaction (and/or banking) server SrvT, etc.). A communication terminal TCom, for example a smartphone is also connected to a communication network NtWK (which can be identical to or different from the previous ones) and to the authentication server of the voice control device (when the latter uses such authentication services) or to another server communicating with the authentication server SrvCA.

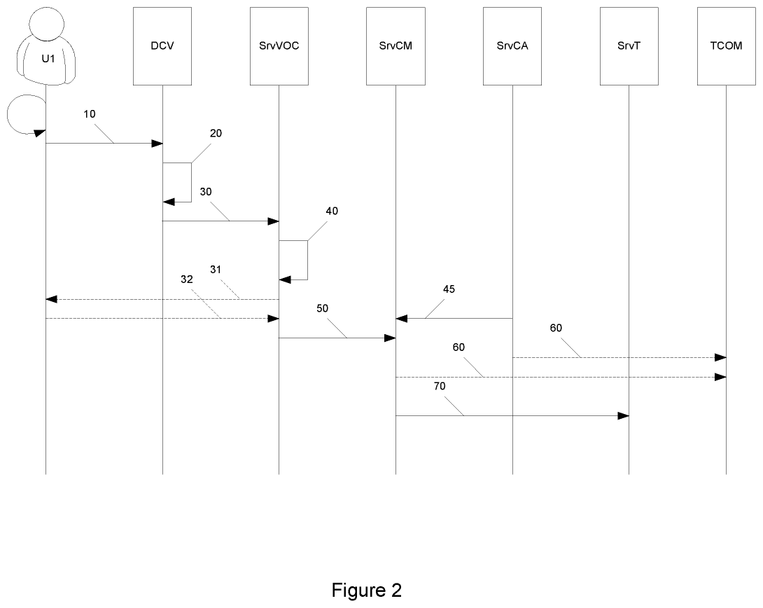

FIG. 2 illustrates a typical example of interaction between the voice control device DCV of the prior art and the other components of the system of FIG. 1 within the scope of the implementation of a purchase order of goods or services. The direction of the arrows is important within the scope of this description of the prior art. A user U1, after having used an activation word, vocally orders (10) the purchase of an item by saying one or more phrases captured by the microphone of the voice control device DCV. The voice control device DCV records (20) the order said after the activation word. The order is transmitted (30) to the remote server(s) SrvVoc of the voice service provider for analysis. The voice order is analysed and interpreted (40). If required, a series of questions/answers is implemented (31, 32) between the voice control device DCV and the server SrvVoc to specify the user's choices. When the user's choice is complete, the server SrvVoc orders (50), from a merchant server SrvCM the implementation of the purchase order of goods or services, optionally using authentication material (login/password) and payment (bank identifier; card numbers) obtained (45) from the authentication server SrvCA, for a user account associated with the voice control device DCV. Optionally, if a transaction validation service is activated (optional), the merchant server SrvCM and/or the authentication server SrvCA transmits (60) to the communication terminal of the user TCOM whose account is associated with the voice control device DCV, a request to obtain a transaction authorisation code. On validation of the order by the user (or directly if no verification is carried out), the merchant server SrvCM implements (70) the payment transaction corresponding to the order of goods or services in coordination with the transaction server SrvT and the server SrvVoc confirms the validation of the order to the voice control device DCV. As explained above, it is therefore observed that the processing of the purchase order placed by the user is essentially carried out at the level of the servers of the voice service provider and potentially not blocked by the user.

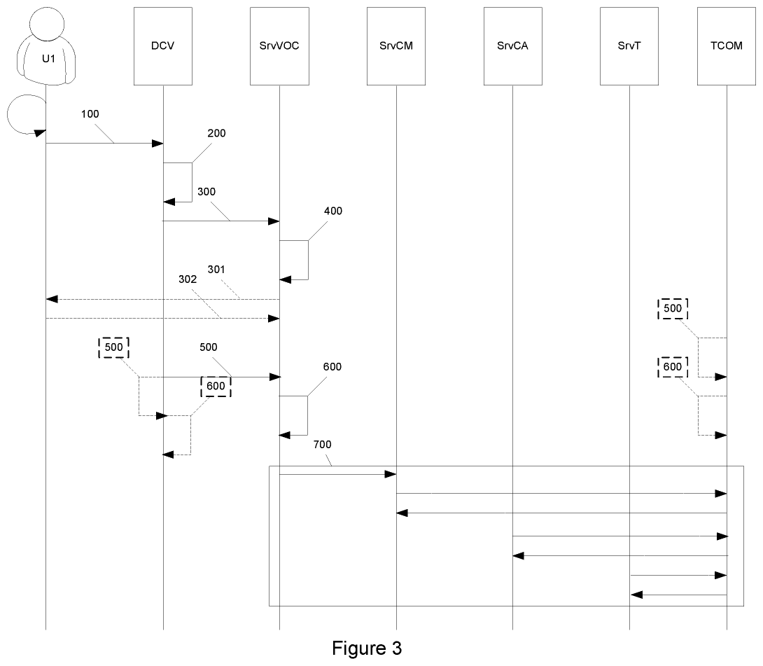

FIG. 3 illustrates the interaction between the voice control device DCV according to the invention and the other components of the system of FIG. 1 within the scope of the implementation of a purchase order of goods and services also according to the invention. The direction of the arrows is important within the scope of this description of the invention.
A user U1, after using an activation word, vocally orders (100) the purchase of an item by saying one or more phrases captured by the microphone of the voice control device DCV;
The voice control device DCV records (200), in a memory, the order said after the activation word;
The order is transmitted (300) to the remote server(s) SrvVoc of the voice service provider for analysis, via a suitable data transmission protocol, such as HTTP/2;
The voice order is received, analysed and interpreted (400). If required, a series of questions/answers (301, 302) is implemented between the voice control device DCV and the server SrvVoc to specify the user's choices;
Concomitantly, or subsequently, a current voiceprint of the user U1 is obtained (500) using the words said by the user U1 placing the purchase order of goods or services;
   The current voiceprint can be obtained in at least three ways, as disclosed hereinafter, according to the capabilities and the features of the voice control device DCV (the dotted lines represent the embodiments);
The current voiceprint is compared (600) with a reference voiceprint;
   Three comparison methods are described hereinafter, in relation to the different embodiments (the dotted lines represent the embodiments);
If the current voiceprint corresponds to the reference voiceprint, authorisation (700) of the implementation of the purchase order of goods or services;
   The authorisation can be implicit or explicit, as described hereinafter in relation to different embodiments; this authorisation, however, implements either the communication terminal paired with the voice control device, the communication terminal being in possession of the payment data implemented to process the transaction, or a specific electronic device, located in the communication network, in charge of making the payment. Both embodiments are described hereinafter.

Thus, as disclosed above, the invention adds security in the processing of payment transactions originating from a voice control device DCV. Indeed, on one hand, it is no longer necessary to load payment data at server level, as it is currently the case. In some embodiments, it is not even necessary to load identification data on servers, as it is also currently the case. Indeed, the servers, in the processing of a payment transaction, according to the invention, receive data temporarily, in an encrypted way, of which they cannot take cognizance. Only the transaction server, which ultimately executes the transaction is capable of taking cognizance of the confidential data transmitted. Thus, from the viewpoint of the voice control device, which is the device about which the order of goods or services is structured within the scope of the invention, the method described above, comprises the steps of:
Obtaining, using the capturing component, at least one data item representative of a voice-based purchase order, said purchase order emanating from the voice of a user and relating to the purchase of at least one good or one service;
Authenticating at least one voiceprint representative of said user based on said at least one data item representative of the purchase order; and
If said at least one voiceprint representative of said user corresponds to a user authorised to make purchases using said electronic voice control device, transmitting, to a processing device to which said electronic voice control device is connected, a request to obtain a purchase authorisation, said request comprising at least one data item representative of the payment transaction.

Two main implementations are envisaged: one comprising a series of exchanges between the voice control device and a communication terminal of the user whose voiceprint is authenticated (the user's communication terminal then acting as the processing device, either completely, or as an intermediary); the other implementation consists of two-factor authentication of the user (two-factor voice authentication), carried out by a voice service server and obtaining the user's voice-based consent.

To implement the invention in concrete terms, in an embodiment, the modifications to be made to the voice control device DCV consist of equipping it with a microphone and a speaker wherein the emission and reception frequency ranges comprise ultrasounds. In the present invention, “communication by ultrasound” is a communication method for transmitting data via the sound of an ultrasound waveband as a medium. For example, a sound of a frequency band from 18 to 20 kilohertz (Khz) is transmitted (via a speaker) or received (via a microphone) to send and receive data, and particularly digital data, according to a suitable transmission protocol.

According to the embodiments, the current voiceprints and the reference voiceprints are processed differently. As regards the reference voiceprint, it is recorded in the servers of the voice service provider. Particularly, this reference voiceprint is associated with a user in a biometric database. The biometric database comprises a set of recordings, each recording corresponding to a given user and a reference voiceprint is associated with this user. A user can have several reference voiceprints in the database (and therefore several recordings), these reference voiceprints corresponding for example to several different timepoints and/or entries of the same user. The biometric database is secure. This means that encryption mechanisms are applied to the database recordings to prevent unlawful access and/or uses of the data contained therein. More particularly, a user's reference voiceprint is encrypted using a cryptographic system based on encryption keys, of which a master key is for example defined during the recording (“opt_in”) of the user and the recording of the reference voiceprint. If this technique is used, the comparison of the reference voiceprint with a current voiceprint comprises obtaining a current encryption key which is used to derive, based on the current voiceprint, an encrypted version of the current voiceprint. The comparison of the current voiceprint with the reference voiceprint then comprises the comparison of the encrypted version of the current voiceprint with the encrypted version of the reference voiceprint. This encrypted version is obtained by applying a key exchanged between the devices belonging to the system (server, voice control device, communication terminals). Preferably, it consists of a session key which can be derived from the master key, the derivation of the session key being carried out when establishing an encrypted data transmission link between two of the devices belonging to the system.

Moreover, a user's reference cryptographic print (or an encrypted version of this reference cryptographic print) can be transmitted to one or more banking servers or transaction servers. Typically, the reference cryptographic print is communicated to the user's banking server, for example during a registration phase of the user to a voice-based payment service. Alternatively, a bank server can have its own specific reference cryptographic print, this print being generated independently of the reference cryptographic print of the voice service provider server.

The current cryptographic print, for its part, is computed in several different ways, as disclosed hereinafter.

### 5.2. Description of Embodiments

### 5.2.1. Obtaining and Comparisons of the User's Current Voiceprint

In a first embodiment, the comparison of the current voiceprint and the comparison with the reference voiceprint is performed in the voice control device itself. In this scenario, the processing means which are comprised in the voice control device (processors, memory, network interfaces (wired, wireless), proximity communication interfaces (Bluetooth, NFC)), are assisted, if required, by voice authentication means. Such means can be presented in the form of dedicated processors or secure processors, specifically dedicated to the implementation of these user authentication operations. The confirmation of authentication of the user placing the order is therefore obtained by a module within the voice control device itself, without interacting with other devices. This embodiment has the advantage of not mobilising resources either at network level or at communication terminal level. It also has the advantage of being quick to implement.

In a second embodiment, the comparison of the current voiceprint and the reference voiceprint is performed in the communication terminal paired with the voice control device. More particularly, in this embodiment, the voice control device transmits a digitised voice sample to the paired communication terminal. This transmission can be implemented either by conventional transmission means (Bluetooth, nfc) or via an inaudible digitised audio signal, as described within the scope of the transmission of the transaction data. More particularly, using a speaker, the voice control device forms an audio sequence in the ultrasound range. This audio sequence is captured by the paired communication terminal and recorded. If needed, the processing of these data implements an instant application, downloaded automatically from the communication terminal on receipt of the digitised audio signal. The digital data which are recorded in this audio sequence are then decoded and recorded in the communication terminal. The digital data are transmitted using a suitable communication protocol. The digital data are inserted into a frame which is emitted to the communication terminal. Two scenarios can be envisaged: either the digital data represent the user's current voiceprint, which is therefore computed by the voice control device prior to the transmission thereof; or the digital data represent a digitised sample of the user's voice. In this second scenario, the communication terminal converts this digitised sample into a current voiceprint. The implementation of either of the two scenarios can be decided, on a case-by-case basis or according to the operational constraints (particularly processing capabilities of the voice control device). Once in possession of the user's current voiceprint, the communication terminal makes a comparison of this current voiceprint with a reference voiceprint. If this comparison is positive, the communication terminal transmits an authentication confirmation to the voice control device. The communication terminal, in this example, acts as a certification terminal of the authenticity of the voice of the user authorised to place orders and make corresponding payment transactions. This second embodiment has the advantage of not requiring the use of network resources (remote server) and therefore protects against unintended disclosure of the voiceprint, in the case of a problem on the server.

In a third embodiment, obtaining the current voiceprint is implemented by a server of the voice service provider. More particularly, as voice orders are received from the user, for example during steps (100, 200, 300) described above, the server of the voice service provider computes a current voiceprint of the user. Two scenarios are then envisaged: in the first scenario, the server of the voice service provider has the reference voiceprint and performs the comparison of the current voiceprint and the reference voiceprint itself and delivers the confirmation of authentication of the user using a specific application (a service) implemented on the server of the voice service provider. In this case, the server of the voice service provider acts as a certifying third-party of the reference voiceprint. In the second scenario, which is preferred, the server of the voice service provider does not have the reference voiceprint, which is recorded either on the voice control device or on the communication terminal. Therefore, the server builds a response to the voice control device, response comprising a data field comprising the current voiceprint in the form of a signature.

In this second scenario, the comparison is performed either as in the first embodiment or as in the second embodiment described above. The second scenario has the advantage of making use of the processing capabilities of the server and therefore of a superior voice sample processing potential.

Following the implementation of any one of these embodiments, the voice control device has a confirmation (or a negation) of the identity and a strong authentication of the user placing the order of goods and services using the voice control device. In the case of user authentication, the order process continues to implement a payment transaction. This process is implemented by means of the communication terminal of the authenticated user, which acts as a provider of the data required for payment, and particularly of the bank card data. The implementation of the purchase order is described hereinafter.

### 5.2.2. Implementation of the Purchase Order of Goods or Services

If the user is authenticated and the order is validated by the user, the processing of the payment transaction can be implemented. More particularly, the processing of the payment transaction comprises the supply, by the communication terminal, of at least one payment data item and/or at least one identification data item (credential) required for the implementation of the transaction. The use of the communication terminal is performed as follows, using a transmission and interaction technique not requiring user intervention on the communication terminal.

Beforehand, it is assumed that the voice control device has, in the memory thereof, a confirmation data item of user authentication and/or that the communication terminal has this data item as it performed the comparison of the voiceprints itself. In the first case, the voice control device transmits this confirmation to the communication terminal.

In any case, the voice control device receives, from the server SrvVoc, a request to obtain payment and/or identification data. This request is transmitted using the communication network and the suitable transmission protocol (for example HTTP/2 and a push mechanism enabling the server to transmit the data required to the client). The voice control device receives the request from the server and builds its own request intended for the communication terminal, using a suitable transmission protocol and mode. Preferably, the ultrasound transmission mode is used. The request to obtain payment data is transmitted to the communication terminal. On receipt of this request, the communication terminal retrieves the payment data and/or the identification data required. The communication terminal obtains these data which are recorded in a memory of the communication terminal. Preferably, the memory in question is secure and the data are handled by means of a secure execution environment, for example using its own secure processor in order to ensure the security of these data. The communication terminal then builds a response comprising the required data and transmits these data to the voice control device. Advantageously, this request/response exchange between the communication terminal and the voice control device is preceded by a cryptographic material exchange for encrypting the communications. In an alternative embodiment, the voice control device provides a public key to the communication terminal and in the same way the communication terminal provides a public key to the voice control device. This cryptographic material exchange makes it possible to ensure that the data transmitted (for example via the microphones and speakers of the devices and ultrasonic transmission) will not be compromised, even if a malicious device is listening to the ultrasonic digital data exchanged. This prior cryptographic material exchange can advantageously also be implemented during the voice data exchange, described above within the scope of obtaining and comparing the voiceprints.

If the voice control device receives the payment and/or identification data from the communication terminal, it deciphers these data using its private key (where applicable) and transmits these data securely to the server SrvVoc. In possession of these data, the server SrvVoc communicates them either to the merchant server, or directly to the transaction server, so that the payment transaction can be carried out. In this way, the payment and/or identification data required for processing the transaction are therefore not necessarily available to the server SrvVoc and a genuine authentication is implemented for the payment.

Alternatively, the payment data are available at the level of the server, but the use of these payment data can be subject to the generation of a one-time password, and this one-time password is generated either by the voice control device, based on the authentication of the speaker's voice, or by the communication terminal, also based on the authentication of the speaker's voice. The server in charge can also, at its end, generate a reference one-time password, on the same basis (reference voiceprint of the user), and, to make the payment the current one-time password is transmitted to the server in charge to validate the payment (i.e., to validate the use of the payment data to perform the transaction).

In an alternative or additional embodiment, which has a superior confidentiality advantage, the following process is implemented. The voice control device receives, from the server SrvVoc, a request to obtain payment and/or identification data. This request is transmitted using the communication network and the suitable transmission protocol (for example HTTP/2 and a push mechanism enabling the server to transmit the data required to the client). This request comprises, on one hand, a data item representative of the data required and a location address to which the data must be supplied. The voice control device forms itself a request to the communication terminal. On receipt of this request, the communication terminal, as above, obtains the required data. However, rather than transmit these data to the voice control device, it logs in securely to the required location address and transmits these data directly to this address. Advantageously, this address can be an address of the merchant server and/or an address of the transaction server in charge of managing the transaction. In this way, neither the voice control device, nor the server SrvVoc come into possession of these data. Thus, the confidentiality thereof is preserved from this point of view. In this alternative, also, instead of the payment or authentication data, a one-time password can be transmitted, which is generated on the basis of the voiceprint, and a reference one-time password, generated on the basis of the reference voiceprint, is also computed by the server in charge for comparison. If both one-time passwords match, the use of the payment data (which are either on a TCOM or DCV device, or on one of the servers) is authorised.

Moreover, technically, in the two embodiments described above, the implementation of the transmission of the data by the communication terminal can comprise the execution of a specific application, called instant application. This instant application is optionally downloaded (if not already present in the communication terminal). This instant application can advantageously be present at the location address provided by the server SrvVoc. When it goes to the address indicated, the communication terminal downloads and/or executes the instant application pointed by this link. The instant application then implements the steps described above. Additionally, in order to reassure users averse to the idea of being able to order without any digital interaction with the communication terminal, a confirmation can be requested by the user on the communication terminal, either by entering a code, as it is currently the case, or merely by accepting the transaction (click on accept payment transaction button). If the application used is not an instant application, it can for example take the form of a conventional banking application in possession of the client.

The advantage of implementing an instant application lies in that it can be designed for and/or by the merchant, to adapt to the information system thereof and therefore to facilitate the processing of orders placed vocally using the technique according to the invention. This has numerous advantages: this makes it possible to ensure that the merchant is not dependent on the ecosystem implemented by the voice service provider and this makes it possible to ensure that the user has the choice of purchasing via other merchant services than those offered by the voice service provider.

A further advantage of the instant application is that it does not reside in the permanent memory of the communication terminal: it is loaded as needed, to receive the voiceprint and/or the purchase order. At the end of its task, it simply disappears from the communication terminal and leaves no trace thereon.

Moreover, this makes it possible to ensure also that the communication terminal always has the most recent version of the instant application, and therefore makes it possible to ensure that the data exchange protocols and the cryptographic protocols can be adapted, continuously to the compliance and security requirements adapted to the payment, particularly via a voice interface.

Concerning the payment per se, it is implemented by the merchant server and a transaction server. Advantageously, the transmission of the payment data comprises, in at least one embodiment, the use of the current voiceprint. Thus, for example the current voiceprint is used to contextualise the payment transaction. This contextualisation can take two forms, according to the embodiments:
An encrypted version of the current voiceprint is used instead of a payment data verification field; more particularly, an encrypted version of the current voiceprint is used instead of the verification code (CVV) of the user's bank card. The advantage of this solution is making the payment conditional on the verification of the reference voiceprint while not modifying the overall payment architecture; the transaction server (or the banking server), receives the payment data (card number, expiry date, name of cardholder, and encrypted version of the current voiceprint) from the merchant server and compares these data received to the data in its possession: particularly a comparison of the encrypted version of the current voiceprint is performed with respect to the encrypted version of the reference voiceprint. If the data are valid, the transaction server implements the payment.
An encrypted version of the current voiceprint is used to generate a transactional token based on the payment data in the possession of the merchant server; more particularly, an encrypted version of the current voiceprint is used to generate, using an encryption or hash function, a payment token which is transmitted to the transaction server. On receipt thereof, the transaction server computes the same token, using the data in its possession and compares the tokens. If they are identical, the payment transaction can be executed. The computing of the token can implement the following technique:

Token=Hash(EvC,DP)
Wherein:
   Token is a payment token;
   Hash is a hash function;
   EvC is an encrypted version of the current voiceprint;
   DP is a payment data grouping function (for example concatenation, binary or hexadecimal subtraction, rotation, etc.).

Such implementations make it possible to link the payment implementation directly to the voice-based control and authentication of the user, and therefore increase the security of transactions on one hand, by authenticating the user and increase the security of the payment, on the other, by looping user authentication with the payment data used.

### 5.3. Electronic Processing Device Used in a Communication Network

Within the scope of an implementation in a communication network, the use of a communication terminal paired with the voice control device is not required. It is however necessary to ensure a certain level of payment security. Particularly, it is necessary to implement obtaining purchase consent, this purchase consent being authenticated. In the embodiment described above, the purchase consent is obtained via the communication terminal, with optionally the use of a specific code, in the possession of the user authorised to make the payment. In this embodiment, rather than interacting with the user's communication terminal, it is ensured that the user's consent is obtained vocally by:
carrying out at least a second voice authentication: i.e., by comparing at least a second current voiceprint with the reference voiceprint; and
by explicitly requesting the user's consent;

The voice authentication, described above, is here implemented at least twice: at the start of or concomitantly with the order placed by the user: one or more current voiceprints are computed, at different times of the placing of the order: this makes it possible to ensure that, on one hand, the authorised user is indeed the user placing the order, and, on the other, that someone else is not taking their place after the first voice authentication has taken place.

Obtaining the user's consent is carried out as follows: the merchant server transmits, to the voice service server, a request to obtain consent; the voice service server transmits this request to the voice control device which plays it in voice form to the user, for example in the form: “do you accept to pay €/$ X for the purchase of: [ . . . ]” detailing the user's purchase basket; the latter then says an acceptance phrase such as “yes I accept this payment/this order”. Obtaining consent also comprises computing a so-called “consent” voiceprint which is compared to the reference voiceprint. If the consent is obtained vocally and the current “consent” voiceprint corresponds to the reference voiceprint, the transaction is validated.

This transaction validation comprises:
on one hand, transmission by the voice service server, of a confirmation of authentication of the current voiceprint, to the merchant server; and
on the other, transmission of the user's response, converted to text form, to the merchant server.

On receipt of these data, the merchant server implements a payment transaction based on obtaining the user's payment data, which are already available to the merchant server (for example because the user provided these data previously when registering on the merchant server's website).

### 5.4. Additional Embodiment

In an additional embodiment, the methods described above are not implemented merely using the voice control device as a gateway device. More particularly, during the order on the voice control device DCV, the DCV can send an order to the communication terminal so that it uses its own capturing device (the microphone) and transmit what it hears to the instant application of the communication terminal (passing via the default listening mode of the operating system of the communication terminal, which then starts the instant application) and the steps described above are implemented not by the voice control device but by the communication terminal which then acts as a voice control device. The advantage of this embodiment is that it ensures that sensitive data (voiceprint, authentication data, payment data, are used and transmitted only between the user's communication terminal, equipped with a TEE and/or a secure element and the server(s) in charge, without passing via the voice control device.

### 5.5. Other Features and Advantages

With reference to FIG. 4, a simplified architecture of an electronic voice control device is shown, capable of performing the processing of a purchase order of goods or services placed vocally by a user. An electronic voice control device comprises a memory 41, a processing unit 42 equipped for example with a microprocessor, and controlled by a computer program 43, implementing the method as described above. In at least one embodiment, the invention is implemented in the form of an application installed on this device. Such a device comprises, according to the embodiments:
means for obtaining, by means of the capturing component, such as a microphone, at least one data item representative of a voice-based purchase order, said purchase order emanating from a user's voice;
means for identifying at least one good or service corresponding to said purchase order based on said at least one data item representative of the purchase order; these means can be implemented in conjunction with a server with which the voice control device is connected;
means for authenticating at least one voiceprint representative of said user based on said at least one data item representative of the purchase order; and
If said at least one voiceprint representative of said user corresponds to a user authorised to make purchases using said electronic device, means for transmitting, to another device to which said electronic device is connected, a request to obtain a purchase authorisation, said request comprising at least one data item representative of the payment transaction.

As explained above, these means are implemented by means of modules and/or components, which are for example secure. They thus make it possible to keep the data required for payment confidential and only authorise a voice-controlled purchase when the user placing the order is authenticated (and therefore authorised to do so).

Although the present disclosure has been described with reference to one or more examples, workers skilled in the art will recognize that changes may be made in form and detail without departing from the scope of the disclosure and/or the appended claims.

1. A method for processing a purchase order of goods or services, said method being implemented within an electronic voice processing device comprising at least one component for capturing voice orders, called a capturing component, and a sound emission component, called an emission component, herein the method comprises:
obtaining, using the capturing component, at least one data item representative of a voice-based purchase order, said purchase order emanating from a voice of a user and relating to the purchase of at least one good or service;
authenticating at least one voiceprint representative of said user based on said at least one data item representative of the purchase order;
determining whether said at least one voiceprint representative of said user corresponds to a user authorised to make purchases using said electronic voice control device; and
transmitting, to an electronic processing device to which said electronic voice control device is connected, a request to obtain a purchase authorisation, said request comprising at least one data item representative of the payment transaction, as a function of the determination.

2. The method for processing a payment transaction according to claim 1, wherein the electronic processing device is a communication terminal with which said voice control device has been previously paired.

3. The method for processing a payment transaction according to claim 2, wherein the transmitting the request to obtain a purchase authorisation to the communication terminal with which said electronic device is paired comprises:
building the request to obtain the purchase authorisation;
activating the emission component of the electronic device;
generating a sound according to the request to obtain the purchase authorisation; and
emitting said sound using the emission component.

4. The method for processing a payment transaction, according to claim 3, wherein said sound emitted by said electronic voice processing device is situated in the ultrasound range.

5. The method for processing a payment transaction, according to claim 1, wherein the method further comprises, after transmitting the request to obtain a purchase authorisation, receiving a payment transaction acceptance response.

6. The method for processing a payment transaction, according to claim 5, wherein the method further comprises, after receiving a payment transaction acceptance response, transmitting a data structure representative of the payment transaction to a transaction server.

7. The method for processing a payment transaction, according to claim 6, wherein the data structure representative of the payment transaction comprises at least one data item representative of a current voiceprint.

8. The method for processing a payment transaction, according to claim 7, wherein said at least one data item representative of a current voiceprint is used to replace at least one payment data item of a payment card of said user.

9. The method for processing a payment transaction, according to claim 7, wherein said at least one data item representative of a current voiceprint is used to build a payment token using at least one payment data item of a payment card of said user.

10. An electronic voice control device, device being capable of processing a purchase order of goods or services, of an electronic voice processing device comprising at least one component for capturing voice orders, called a capturing component, and a sound emission component, called an emission component, said electronic voice control device comprising:
a data processor; and
a non-transitory computer-readable medium comprising instructions stored thereon which when executed by the processor configure the electronic voice control device to:
obtain, using the capturing component, at least one data item representative of a voice-based purchase order, said purchase order emanating from a voice of a user and relating to the purchase of at least one good or service;
authenticate at least one voiceprint representative of said user based on said at least one data item representative of the purchase order;
determine whether said at least one voiceprint representative of said user corresponds to a user authorised to make purchases using said electronic voice control device; and
transmit, to an electronic processing device to which said electronic device is connected, a request to obtain a purchase authorisation, said request comprising at least one data item representative of the payment transaction, these transmission means being implemented as a function of the determination of.

11. A non-transitory computer-readable medium comprising program code instructions stored thereon for executing a method of processing a purchase order of goods or services, when the instructions are executed on a processor of an electronic voice processing device comprising at least one component for capturing voice orders, called a capturing component, and a sound emission component, called an emission component, wherein the method comprises:
obtaining, using the capturing component, at least one data item representative of a voice-based purchase order, said purchase order emanating from a voice of a user and relating to the purchase of at least one good or service;
authenticating at least one voiceprint representative of said user based on said at least one data item representative of the purchase order;
determining whether said at least one voiceprint representative of said user corresponds to a user authorised to make purchases using said electronic voice control device; and
transmitting, to an electronic processing device to which said electronic voice control device is connected, a request to obtain a purchase authorisation, said request comprising at least one data item representative of the payment transaction, as a function of the determination.
